(19) United States
(12) Patent Application Publication
(10) Pub. No.: US 2007/0264883 A1
(43) Pub. Date: Nov. 15, 2007

(54) Miniature, round headed battery terminal with dual, upturned flanges

(75) Inventor: Erik Freitag, Arlington Heights, IL (US)

Correspondence Address: MCDERMOTT, WILL & EMERY LLP, 227 WEST MONROE STREET, SUITE 4400, CHICAGO, IL, 60606-5096, US

(73) Assignee: Royal Die & Stamping Co., Inc.

(21) Appl. No.: 11/880,762

(22) Filed: Jul. 24, 2007

Related U.S. Application Data
(63) Continuation of application No. 11/412,613, filed on Apr. 27, 2006, now abandoned.

(51) Int. Cl. H01R 4/38

(52) U.S. Cl. 439/764

(57) ABSTRACT

A one-piece battery terminal connector having a body portion and a ferrule portion. The body portion has a top, and a bottom, and includes a first side surface, and a second, opposed side surfaces. The body portion includes, between a first and second lateral end of the body portion, an aperture for engaging a battery post. The size of the intermediate aperture is variable, permitting the connector to be placed onto, and removed from, its corresponding battery post. The connector further comprises a first upturned flange and a second upturned flange, which together cooperatively form the intermediate aperture. The first lateral end of the battery terminal connector has a generally arcuate periphery, and most preferably a semi-circular periphery. The axial or vertical spacing between the first upturned flange and the second upturned flange is approximately 0.6 times the height of the first upturned flange, or less.

### CROSS-REFERENCE TO RELATED APPLICATIONS

This application is a continuation of U.S. patent application Ser. No. 11/412,613, filed on Apr. 27, 2006, which is expressly incorporated herein by reference.

### FEDERALLY SPONSORED RESEARCH OR DEVELOPMENT

Not Applicable.

### TECHNICAL FIELD

This invention is directed to a miniature, round-headed battery terminal connector, with dual, upturned extrusions, or flanges. The miniature battery terminal connector is especially suited for use in lightweight motor vehicles with limited underhood space.

### BACKGROUND OF THE INVENTION

Storage batteries of the type used in automobiles, trucks and the like generally have a terminal post made of a lead alloy material with a cylindrical or frusto-conical shape. The battery is connected to the vehicle electrical system by a battery cable assembly. The cable assembly has connectors which clamp to the battery posts, providing a secure electrical and mechanical connection.

A conventional connector for connecting cables to the battery is a molded, generally U-shaped device with a bolt passing through outwardly projecting yoke-like arms for securely clamping the connector to the battery post. The connector may also be a stamped metal battery terminal connector, fabricated from sheet metal.

U.S. Pat. No. 5,733,152 (“the '152 patent”) is directed to a battery terminal connector. The '152 patent is owned by the assignee of the present application, and relates to a battery terminal connector which permits improved mechanical and electrical connection to a battery terminal post. The connector of the '152 patent has enhanced resistance to rotation when connected to a battery terminal post. That connector is also economical to manufacture, and can be made by automated assembly and production. An additional advantage of this connector is that it is adaptable to different automobile models and batteries.

U.S. Pat. No. 5,879,202 (“the '202 patent”) is also directed to a battery terminal connector. This connector is of the type that permits it to be tightened on the battery post using a threaded nut that is positioned above, rather than on the side of, the connector. As a result, especially in tight, confining areas found under the hoods of modern automobiles, the nut is more easily accessed during installation of the connector of the '202 patent, as compared to the ease of access to threaded nuts that are secured to the sides of many prior art connectors.

An additional relevant connector is that manufactured by the Chang Hwan Company of South Korea (http://www.cpt.co.kr). This connector includes two upturned flanges that together define the aperture for the battery post. However, this connector is not a miniaturized connector, and is not made of one piece. Because of its multi-piece structure, this Chang Hwan connector requires an additional labor step when the wiring harness is attached to the automobile, during its manufacture. In addition, the junction between the two pieces is a site where corrosion or failure can occur. This junction thus raises the risk of a mechanical or electrical problem, resulting in inconvenience for the consumer, and increasing the potential for warranty costs or public relations problems for the manufacturer. Moreover, this Chang Hwan connector has a threaded rod and nut at its first lateral end, i.e., the end of the connector farthest from the ferrule portion. This structure increases the bulk at the frontal portion of the Chang Hwan connector. In addition, the approximate 5 millimeters distance between the two upturned flanges is roughly equal to the 5 millimeters height of each of those flanges. Accordingly, this connector has a generally high profile, and is thus somewhat less suitable for use in tight, under-hood areas.

Additional relevant prior art references include U.S. Pat. Nos. 6,250,973, 5,941,738, 5,879,202, 5,800,219, 5,738,552, 5,711,688, 5,672,442, 5,599,210, 5,316,505, 4,354,726, 4,063,794, 4,054,355, and 3,568,138. None of these patents, however, alone or in combination, disclose the present invention.

### SUMMARY OF THE INVENTION

The invention is a one-piece battery terminal connector having a body portion and a ferrule portion. The body portion has a top and a bottom.

The body portion further includes a first side surface, and a second, opposed side surface. Moreover, the body portion includes, between a first and second lateral end of the body portion, an aperture for engaging a battery post. The size of this intermediate aperture is variable. By varying the size of the intermediate aperture, the connector can be placed onto, and removed from, its corresponding battery post. Preferably, the size of the intermediate aperture can be varied by means of a threaded rod and nut. Preferably, the threaded rod and nut are positioned at the second lateral end of the body portion.

The connector further comprises a first upturned flange and a second upturned flange. Together, the first upturned flange and the second upturned flange cooperatively form the intermediate aperture.

Preferably, the battery terminal connector is made of a copper alloy. Most preferably, the battery terminal connector is made of a C-194 copper alloy.

The first lateral end of the battery terminal connector has a generally arcuate periphery, and most preferably a semi-circular periphery.

In the most preferred embodiment of the invention, the spacing between the first upturned flange and the second upturned flange is approximately 0.6 times, or less, the height of the first upturned flange.

### BRIEF DESCRIPTION OF THE DRAWINGS

FIG. 1 is a perspective view of a preferred embodiment of the battery terminal connector of the present invention;

FIG. 2 is a top view of the connector of FIG. 1;

FIG. 3 is a right side view of the connector of FIG. 1;

FIG. 4 is a perspective view of the connector of FIG. 1, and highlighting the left front corner of that connector; and

FIG. 5 is a perspective view of the connector of FIG. 1, and highlighting the right front corner of that connector.

### DETAILED DESCRIPTION

There are many possible embodiments of this invention. The drawings and description below describe in detail a preferred embodiment of the invention. It should be understood that the present disclosure is to be considered as an example of the principles of the invention. The disclosure is not intended to limit the broad aspect of the invention to the embodiments illustrated.

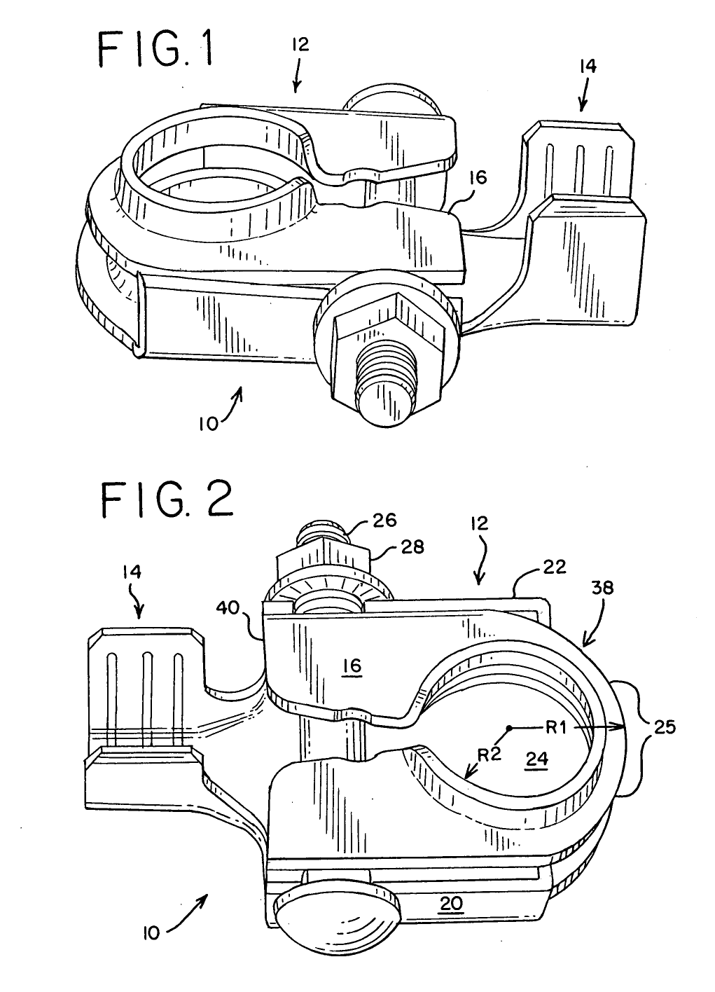

Referring to the drawings, FIG. 1 shows a perspective view of one embodiment of the battery terminal connector 10 in accordance with the invention. The one-piece connector 10 comprises essentially two main portions, including a body portion 12 and a ferrule portion 14. The battery terminal connector 10 is preferably made of copper or a copper alloy. The most preferred copper alloy is a C-194 alloy.

The connector 10 may be formed from a metal blank, such as a single piece of copper or sheet metal. Manufacturing the connector 10 by a stamping process from a single blank is convenient and cost-efficient.

The body portion 12 is typically fitted over a frusto-conical shaped terminal post (not shown) of a storage battery for an automobile or other motor vehicle.

The ferrule portion 14 is adapted for electrically connecting and securing a battery cable (not shown) through the body portion 12 to the terminal post (not shown) of the vehicular battery. The insulation-free end of the battery cable is placed onto the malleable ferrule 14. Then, the sides of the ferrule 14 are pushed towards each other so as to firmly grip, and in this way mechanically and electrically secure, the uninsulated portion of that cable to the ferrule 14.

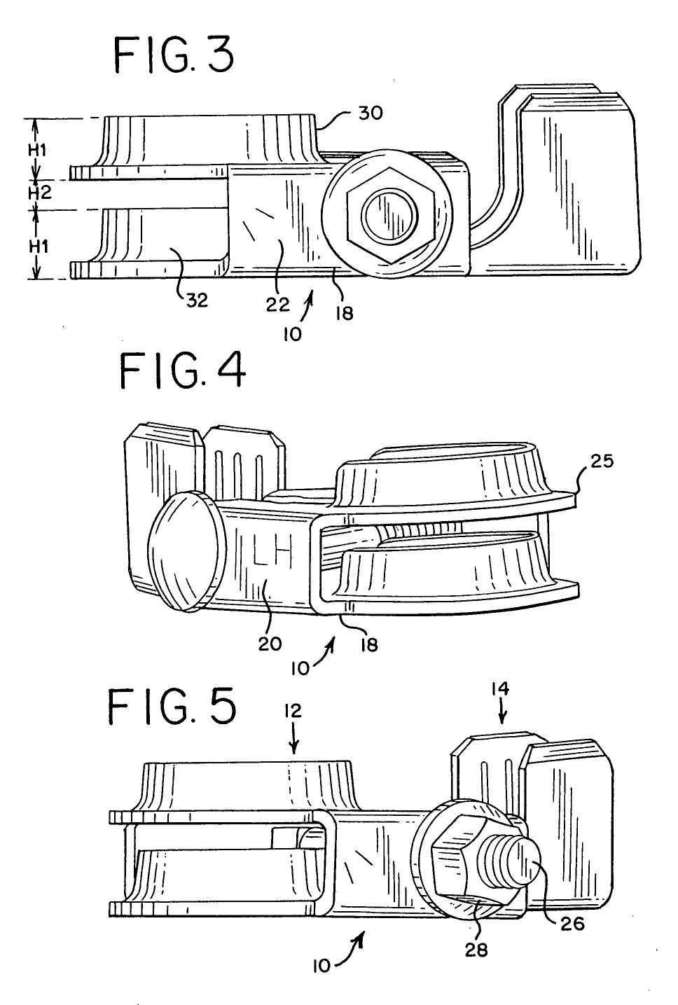

As shown in various figures, the body portion 12 includes a number of surfaces. FIGS. 1 and 2 show a top surface 16, FIGS. 3 and 4 show a bottom surface 18, and FIG. 2 shows a pair of opposite side surfaces 20 and 22.

The battery terminal connector 10 also has, as shown in FIG. 2, an intermediate aperture 24. This intermediate aperture 24 permits the connector 10 to engage the terminal post of the vehicular battery.

The size of the intermediate aperture 24 varies. Particularly, the size varies from (a) at a minimum, a size wherein the inner periphery of the aperture tightly engages the exterior of the battery post, to permit normal operation of the battery in the vehicular electrical system; to (b) at a maximum, a size wherein the periphery of the aperture is spaced apart from the exterior of the battery post, so as to permit either removal of the connector 10 from the battery, and then the removal of the battery from the vehicle, or alternatively the servicing, replacement, or cleaning of the battery terminal connector 10.

In order to facilitate the opening or closing of this aperture 24, the second lateral end 40 of the body portion 12 includes a separate threaded rod 26 and nut 28. By turning the nut 28 clockwise on the threaded rod 26, the nut 28 or its integral flange presses upon the wall of the side surface 22, pushing that side surface 22 closer to the opposite side surface 20, and thereby causing a shrinking in the effective diameter of the aperture 24.

Conversely, by turning the nut 28 counterclockwise on the threaded rod 26, the nut 28 moves away from and thus relieves the pressure upon the wall of the side surface 22. The natural spring tension of the connector 10 causes the side surfaces 20 and 22 to separate, and return to their original positions. This causes an increase in the effective diameter of aperture 24.

Significantly, the connector 10 includes a first upturned extrusion or flange 30, and a second upturned extrusion or flange 32. The second upturned flange 32 is axially spaced apart from the first upturned flange 30. It is this first upturned flange 30 and the second upturned flange 32 that cooperatively form the intermediate aperture 24.

In this embodiment, as may be seen in FIG. 3, there is a relatively small distance between the bottom of the first upturned flange 30 and the top of the second upturned flange 32. This space H2 is shown in FIG. 3.

In this preferred embodiment, the height H1 of both the first upturned flange 30 and the second upturned flange 32 is approximately 5 millimeters. The distance H2 between the upturned flanges 30 and 32 is approximately 3 millimeters. As a result, in this most preferred embodiment, the distance H2 is approximately 0.6 (H1).

As may best be seen in FIG. 2, the first lateral end 38 of the body portion 12 has a rounded frontal portion 25. In particular, as may be seen in FIG. 2, this rounded frontal portion 25 has a generally arcuate periphery.

In the most preferred embodiment of the invention, however, this generally arcuate periphery is a generally semi-circular periphery. The “semi-circular periphery” can best be seen in FIG. 2. In that FIG. 2, R1 is the radius of the semi-circular periphery of the rounded frontal portion 25. In that same FIG. 2, R2 is the radius of the aperture 24.

In the most preferred embodiment, R2, the radius of the aperture 24, in its opened position, is approximately 10 millimeters. In this same most preferred embodiment, R1, the radius of the semi-circular periphery, is approximately 13 to 14 millimeters.

In the preferred embodiment, the battery terminal connector 10 of the invention is made of a copper alloy. In the most preferred embodiment of the invention, the copper alloy is C-194.

As a result of the present structure, the present battery terminal connector 10 can be placed in more confined areas, such as the under-hood areas of modern, more compact automobiles. These advantages result from a combination of the structural features of the invention, including (a) the general reduction in the size of the present connector; (b) the body portion having a first lateral end with a generally arcuate periphery; (c) the positioning of the clamping means, i.e., the threaded rod and the nut, at the second lateral end of the body portion; (d) the provision of first and second upturned extrusions or flanges, each having a height of approximately H1, to cooperatively form the intermediate aperture; and (e) the provision of a space H2 between the first and second upturned flanges of approximately 0.6 (H1), or less.

While specific embodiments have been illustrated and described, numerous modifications come to mind without significantly departing from the spirit of the invention, and the scope of protection is only limited by the scope of the accompanying Claims.

What is claimed is:

1. A one-piece battery terminal connector having a body portion; the body portion having a top; a bottom; a first and a second, opposed side surfaces, an intermediate aperture for engaging a battery post; the intermediate aperture having a size that is variable to accommodate placement of the connector onto, and the removal of the connector from, the battery post; and the body portion further comprising a rounded frontal portion, a first upturned flange and a second upturned flange, wherein the first upturned flange and the second upturned flange cooperatively form the intermediate aperture.

2. The battery terminal connector of claim 1, wherein the connector is made of a copper alloy.

3. The battery terminal connector of claim 1, wherein a first lateral end of the body portion has a generally arcuate periphery.

4. The battery terminal connector of claim 3, wherein a second lateral end of the body portion includes a threaded rod and a nut, for varying the size of the intermediate aperture.

5. The battery terminal connector of claim 1, wherein spacing separates the first and second upturned flanges from each other, wherein the first and the second upturned flanges have a height, and wherein the spacing between the first upturned flange and the second upturned flange is approximately 0.6 times the height of the first upturned flange.

6. The battery terminal connector of claim 1, further comprising a ferrule portion.

7. The battery terminal connector of claim 1, wherein a first lateral end of the body portion has a generally semi-circular periphery.

8. The battery terminal connector of claim 1, wherein the battery terminal connector is made of a copper alloy, and wherein the copper alloy is C-194.

9. A one-piece battery terminal connector having a body portion and a ferrule portion; the body portion having a first lateral end with a generally arcuate periphery; and
the connector further having a top; a bottom; a first and a second, opposed side surfaces, an intermediate aperture for engaging a battery post; the intermediate aperture having a size to accommodate placement of the connector onto, and the removal of the connector from, the battery post; and the connector further comprising a first upturned flange having a height of approximately H1 and a second upturned flange having a height of approximately H1, wherein the first upturned flange and the second upturned flange cooperatively form the intermediate aperture, and wherein a distance H2 between the first and the second upturned flanges is less than approximately 0.6 times the height of the first upturned flange.

10. The battery terminal connector of claim 9, wherein the battery terminal connector is made of a copper alloy.

11. The battery terminal connector of claim 10, wherein the copper alloy is C-194 alloy.

12. The battery terminal connector of claim 9, wherein the arcuate periphery is generally semi-circular.

13. A one-piece battery terminal connector having a body portion; the body portion having a top; a bottom; a first and a second, opposed side surfaces; a first and second lateral end; an intermediate aperture for engaging a battery post; the intermediate aperture having a size that is variable to accommodate placement of the connector onto, and the removal of the connector from, the battery post; wherein the second lateral end of the body portion includes a threaded rod and a nut, for varying the size of the intermediate aperture; and the body portion further comprising a rounded frontal portion, a first upturned flange and a second upturned flange, wherein the first upturned flange and the second upturned flange cooperatively form the intermediate aperture.
